(19) United States
(12) Patent Application Publication
(10) Pub. No.: US 2025/0390289 A1
(43) Pub. Date: Dec. 25, 2025

(54) PAGE PROCESSING METHOD, APPARATUS, DEVICE, AND MEDIUM

(71) Applicant: BOE Technology Group Co., Ltd., Beijing (CN)

(72) Inventors: Mingming YANG, Beijing (CN); Yong SUN, Beijing (CN)

(21) Appl. No.: 18/881,263

(22) PCT Filed: Apr. 28, 2023
(86) PCT No.: PCT/CN2023/091645

§ 371 Date: Jan. 3, 2025

(51) Int. Cl. G06F 8/38

(52) U.S. Cl. CPC G06F 8/38

(57) ABSTRACT

The present application relates to a page processing method, apparatus, device, and medium. In response to an operation of generating a target page in a page development platform, a hierarchical relationship among widgets in the generated target page is acquired, so as to acquire attribute information of the widgets based on the hierarchical relationship among the widgets in the target page, where the attribute information at least includes absolute position information of a first widget among the widgets as a root widget and relative position information of a second widget among the widgets as a leaf widget, such that a descriptive language file for the target page is generated based on the attribute information of the widgets.

### CROSS-REFERENCE TO RELATED APPLICATIONS

This application is the U.S. national phase of PCT Application No. PCT/CN2023/091645 filed on Apr. 28, 2023, the disclosure of which is incorporated herein by reference in its entirety.

### TECHNICAL FIELD

This application relates to the field of software development technology, and in particular to a page processing method, apparatus, device, and medium.

### BACKGROUND

Page visualization configuration tool, as a commonly used development and operation tool in the field of software development, can help technicians quickly generate and publish pages. However, the visual configuration pages generated by the page visualization configuration tool are mainly for the technicians to view, such that the technicians can develop pages based on the visual configuration pages.

When developing pages based on the visual configuration pages, the technicians need to develop codes based on the visual configuration pages, such that display of the pages can be implemented based on the developed codes to realize page development.

However, during the page development, the configured pages may need to be modified. In this case, the developed codes need to be modified at the source code level. That is, during the page development, the configured pages may need to be secondarily developed at the source code level. Therefore, there is an urgent need for a page processing method to obtain a source code file with better readability based on the configured pages, so as to modify the configured pages at the source code level and realize secondary development of the pages.

### SUMMARY

The present application provides a page processing method, apparatus, device, and medium, so as to address the deficiencies in the related art.

According to a first aspect of embodiments of the present application, there is provided a page processing method, the method including:
in response to an operation of generating a target page in a page development platform, acquiring a hierarchical relationship among widgets in the target page;
acquiring attribute information of the widgets based on the hierarchical relationship, where the attribute information includes absolute position information of a first widget among the widgets as a root widget and relative position information of a second widget among the widgets as a leaf widget; and
generating a descriptive language file for the target page based on the attribute information of the widgets.

According to a second aspect of embodiments of the present application, there is provided a page processing apparatus, the apparatus including:
a first acquiring module, configured to in response to an operation of generating a target page in a page development platform, acquire a hierarchical relationship among widgets in the target page;
a second acquiring module, configured to acquire attribute information of the widgets based on the hierarchical relationship, where the attribute information includes absolute position information of a first widget among the widgets as a root widget and relative position information of a second widget among the widgets as a leaf widget; and
a generating module, configured to generate a descriptive language file for the target page based on the attribute information of the widgets.

According to a third aspect of embodiments of the present application, there is provided a computing device, including a memory, a processor, and a computer program stored in the memory and executable on the processor, where the processor executes the computer program to implement operations performed by the page processing method according to the above first aspect and any one of embodiments in the first aspect.

According to a fourth aspect of embodiments of the present application, there is provided a non-transitory computer-readable storage medium, in which a program is stored, where the program, when executed by a processor, implements operations performed by the page processing method according to the above first aspect and any one of embodiments in the first aspect.

According to the above embodiments, in response to an operation of generating a target page in a page development platform, a hierarchical relationship among widgets in the generated target page is acquired, so as to acquire attribute information of the widgets based on the hierarchical relationship among the widgets in the target page, where the attribute information at least includes absolute position information of at least one first widget as a root widget and relative position information of at least one second widget as a leaf widget, such that a descriptive language file for the target page is generated based on the attribute information of the widgets. With the scheme according to the present application, the descriptive language file for the target page can be automatically generated, and the descriptive language file can be directly viewed and modified through a browser, which facilitates the secondary development of the page. Moreover, with the present application, the absolute position information used in generating the descriptive language file can be converted into the relative position information, so as to improve the readability of the generated descriptive language file, and thus ensure the readability of the source code subsequently generated based on the descriptive language file.

It is to be understood that the foregoing general description and the following detailed description are exemplary and explanatory only and are not intended to limit the present application.

### BRIEF DESCRIPTION OF DRAWINGS

The accompanying drawings herein, which are incorporated into and constitute a part of this specification, illustrate embodiments consistent with the present application and, together with the specification, serve to explain the principles of the present application.

FIG. 1 is an exemplary schematic diagram illustrating a target page according to an embodiment of the present application.

FIG. 2 is a flowchart illustrating a page processing method according to an embodiment of the present application.

FIG. 3 is a schematic diagram illustrating a hierarchical relationship among widgets according to an embodiment of the present application.

FIG. 4 is a schematic diagram illustrating a hierarchical relationship among widgets according to another embodiment of the present application.

FIG. 5 is a schematic diagram illustrating a hierarchical relationship among widgets according to another embodiment of the present application.

FIG. 6 is a schematic page diagram illustrating a target page according to an embodiment of the present application.

FIG. 7 is a flowchart illustrating a page processing method according to an embodiment of the present application.

FIG. 8 is a flowchart illustrating a process of acquiring a source code file according to an embodiment of the present application.

FIG. 9 is a block diagram illustrating a page processing apparatus according to an embodiment of the present application.

FIG. 10 is a schematic structural diagram illustrating a computing device according to an embodiment of the present application.

### DETAILED DESCRIPTION

Reference will now be made in detail to exemplary embodiments, examples of which are illustrated in the accompanying drawings. When the following description refers to the drawings, the same numerals in different drawings indicate the same or similar elements, unless otherwise indicated. Embodiments described in the following exemplary embodiments are not intended to represent all embodiments consistent with the present application. Rather, they are merely examples of apparatuses and methods consistent with some aspects of the present application as detailed in the appended claims.

The present application provides a page processing method for converting a target page generated by a page development platform with an absolute layout into a page with a relative layout, thereby generating a descriptive language file for the target page based on the page with the relative layout, so as to convert absolute position information used in generating the descriptive language file into relative position information. In this way, the visual configuration of the page can be realized based on the descriptive language file using the relative position information, such that results obtained from the visual configuration process of the page describe the relative layout of the page. Moreover, the relative layout may be used in code development based on the visual configuration page, such that the layout in the visual configuration results of the page can be aligned with the layout used in the code development process, to improve the readability of the generated descriptive language file.

Furthermore, the secondary development of the target page at the source code level is realized based on the generated descriptive language file to improve the readability of the source code file generated based on the descriptive language file, thereby ensuring smooth progress of the secondary development process and improving the page development efficiency.

Descriptive language is a way to create rule language, and is used to build code in a way closer to the business domain and in a way similar to natural language, such that developers can understand the business meaning of the code without too much effort. A descriptive language file is a file composed of codes constructed based on a descriptive language. The descriptive language file can be simply a configuration file. The code in the descriptive language file is easier to understand than a normal configuration file. In general, the descriptive language file may be parsed with the help of a specific parsing framework, and the parsed descriptive language file can be viewed directly through a browser.

It should be noted that the page development platform can provide developers with page development functionality. For example, the page development platform can provide the developers with a development interface that provides a canvas area and a plurality of selectable elements therein for the developers to select from. The selected elements are added to the canvas area for display of a to-be-generated page in the canvas area, and then a target page is generated based on a page style of the to-be-generated page displayed in the canvas area.

It should also be noted that the types of the elements provided by the page development platform are pre-set. The developers can determine the types of the elements to be added according to the actual technical requirements, such that the developers can select the corresponding types of elements from those provided by the page development platform and add them to the canvas area.

Optionally, during page development, the developers can create a project in the page development platform and perform page development under that project. The page development platform may be a World Wide Web (WEB) platform, or a Windows development platform, etc., which is not limited in the present application.

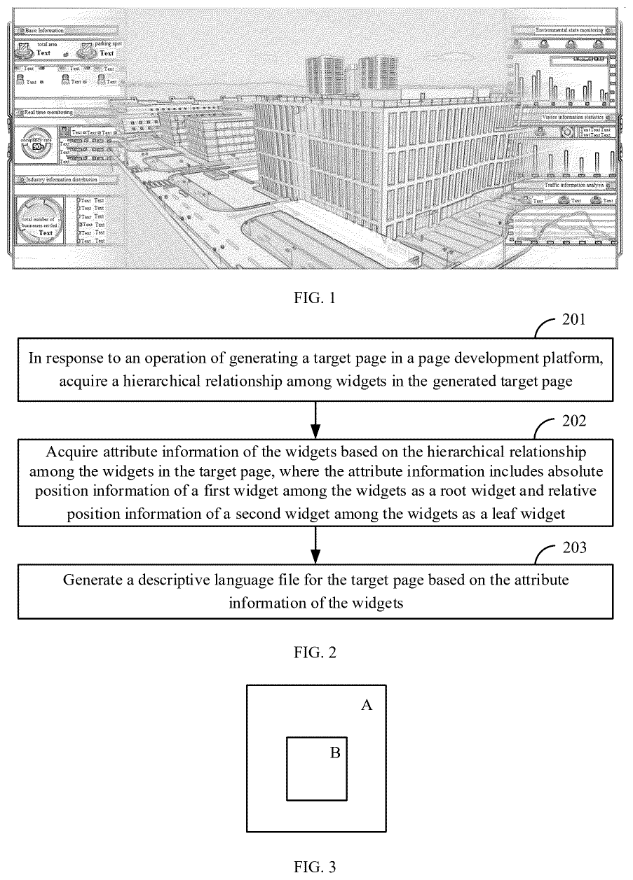

The page processing method may be used to process various types of pages, that is, the page processing method may be used to process any page in any kind of application software. For example, the page processing method may be used to process a page in which a three-dimensional map is displayed. Referring to FIG. 1, FIG. 1 is an exemplary schematic diagram illustrating a target page according to an embodiment of the present application. A three-dimensional map is displayed in the target page as shown in FIG. 1. With the page processing method according to the present application, a descriptive language file for the target page as shown in FIG. 1 in which the three-dimensional map is displayed can be acquired.

The above is only an exemplary description of application scenarios of the present application, and is not intended to limit the application scenarios of the present application. In more possible implementations, the page processing method according to the present application can also be applied in other scenarios involving the page development process, which is not limited in the present application.

The page processing method may be performed by a computing device. The computing device may be a terminal device, such as a desktop computer, a portable computer, a notebook computer, a smart phone, a tablet computer, or a smart watch, which is not limited in the present application.

The application scenarios and implementation environments of the present application have been described, and the page processing method according to the present application will be described in detail below.

Referring to FIG. 2, FIG. 2 is a flowchart illustrating a page processing method according to an embodiment of the present application. As shown in FIG. 2, the method includes steps 201 to 203.

At step 201, in response to an operation of generating a target page in a page development platform, a hierarchical relationship among widgets in the target page is acquired.

The hierarchical relationship may be configured to indicate a display hierarchy among the widgets. For example, referring to FIG. 3, FIG. 3 is a schematic diagram illustrating a hierarchical relationship among widgets according to an embodiment of the present application. As shown in FIG. 3, the widget B is included in the widget A, which, when described as a hierarchical relationship among widgets, means that the widget A is a root widget of the widget B and the widget B is a leaf widget of the widget A.

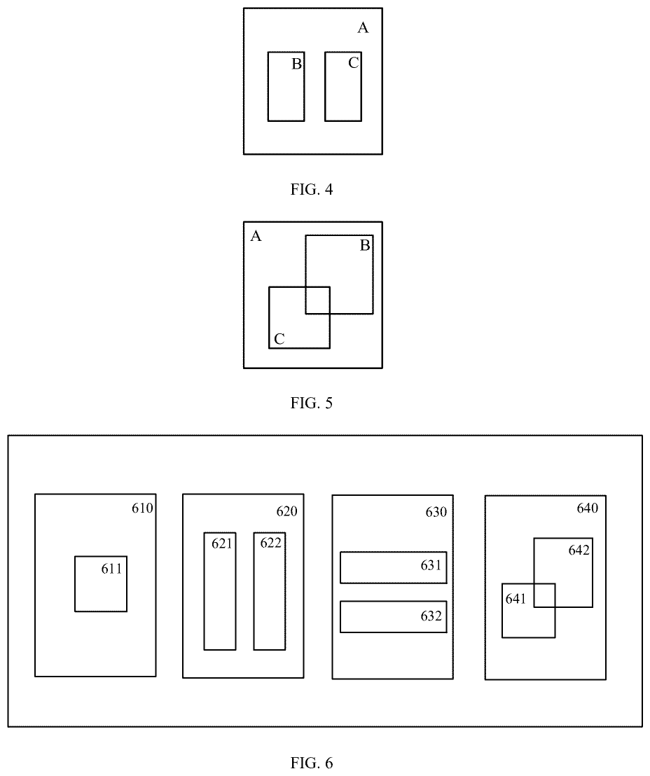

For another example, referring to FIG. 4, FIG. 4 is a schematic diagram illustrating a hierarchical relationship among widgets according to another embodiment of the present application. As shown in FIG. 4, both the widget B and the widget C are included in the widget A without overlap between the widget B and the widget C, which, when described as a hierarchical relationship among widgets, means that the widget A is the root widget of the widget B and the widget C, both the widget B and the widget C are leaf widgets of the widget A, and the widget B and the widget Care of the same hierarchy.

For yet another example, referring to FIG. 5, FIG. 5 is a schematic diagram illustrating a hierarchical relationship among widgets according to another embodiment of the present application. As shown in FIG. 5, both the widget B and the widget C are included in the widget A with overlap between the widget B and the widget C, which, when described as a hierarchical relationship among widgets, means that the widget A is the root widget of the widget B and the widget C, both the widget B and the widget C are leaf widgets of the widget A, and the widget B and the widget C are of the same hierarchy.

At step 202, attribute information of the widgets is acquired based on the hierarchical relationship among the widgets in the target page, where the attribute information includes absolute position information of a first widget among the widgets as a root widget and relative position information of a second widget among the widgets as a leaf widget.

Both the absolute position information and the relative position information are configured to describe the position information of the widget. For a widget, the attribute information may include, in addition to the position information of the widget, a widget identifier and style information of the widget, where the widget identifier may be configured to uniquely identify the widget, and the style information may include a type, a size, a shape, a fill color of the widget, etc. The specific contents included in the attribute information are not limited in the present application.

At step 203, a descriptive language file for the target page is generated based on the attribute information of the widgets.

The descriptive language file may be a DSL (Domain Specific Language) file, or alternatively, another type of file, which is not limited in the present application.

DSL, also known as Domain Specific Language, is a programming language with limited expressiveness designed for specific domains. In some specific domains, the code may not require too many language features for task processing. In order to effectively deal with such tasks, DSL has emerged. As a language tool for solving specific tasks, DSL can be embodied in different types of tasks corresponding to different business domains. For example, for document writing tasks, lightweight markup language (Markdown) may be used as the DSL; for string matching tasks, regular expression (RegExp) may be used as the DSL; for workflow control tasks, dependency detection tool (Make) language or automated build tool (Gradle) language may be used as the DSL; for data search tasks, SQL (Structured Query Language) may be used as the DSL; for web page (Web) style coding tasks, cascading style sheet (CSS) language may be used as the DSL, etc. Code files written in the DSL are DSL files. Accordingly, the DSL files corresponding to different DSLs have different formats. The specific programming languages used for the DSL files and the formats of the DSL files are not limited in the present application.

In summary, the DSLs essentially have the same idea as many solutions to software engineering problems, that is, the complexity is locked in by limiting the boundaries of the problem domain to improve the programming efficiency.

With the scheme according to the present application, the absolute position information used in generating the descriptive language file can be converted into the relative position information, so as to improve the readability of the generated descriptive language file, and thus ensure the readability of the source code subsequently generated based on the descriptive language file.

The basic implementation process of the page processing method according to the present application has been described, and various optional embodiments of the present application will be described below.

In some embodiments, for step 201, when acquiring the hierarchical relationship among the widgets in the target page, in response to the operation of generating the target page in the page development platform, the following steps 2011 and 2012 may be included.

At step 2011, in response to an operation of adding the widgets in the page development platform, the target page is displayed based on the widgets added in the page development platform.

Optionally, the developer may select elements from a variety of elements provided by the page development platform, and drag and drop the selected elements to the canvas area to add the widgets, such that the style of the current page to be generated (that is, the target page) may be displayed in the canvas area in real time.

At step 2012, the hierarchical relationship among the widgets in the target page is acquired, in response to the operation of generating the target page.

Optionally, the page development platform may be provided with a save widget, which may be used to trigger the operation of generating the target page.

It should be noted that, when the developer confirms that the page displayed in the canvas area meets the style of the target page to be generated, the save widget in the page development platform may be triggered, and the computing device may, in response to the triggering operation on the save widget, generate the target page based on the widgets currently included in the canvas area of the page development platform and the style of the widgets.

When the save widget is triggered, the operation of generating the target page is triggered, at which point the computing device may acquire the hierarchical relationship among the widgets in the generated target page.

Optionally, the computing device may, in response to the operation of generating the target page, determine the hierarchical relationship among the widgets in the target page based on a type and position information of each of the widgets in the target page.

In a possible implementation, the widgets included in the target page may be traversed. Each time a widget is traversed, a hierarchical relationship among the currently traversed widget (denoted as “target widget”) and the other widgets in the target page is determined based on the type of the target widget and the position relationship among the target widget and the other widgets.

It should be noted that the computing device may maintain a widget information list for storing the attribute information of the widgets included in the target page. Optionally, each time the developer adds an element to the canvas area, the computing device may store the attribute information of the corresponding widget in the widget information list to enable creation of the widget information list. For example, if the canvas area is empty, the computing device may create an empty list as the widget information list. If the developer adds the first element to the canvas area, the computing device may store the attribute information of the widget corresponding to the element added by the developer in the created widget information list. Each time the developer adds a new element to the canvas area, the attribute information of the widget corresponding to the added element may be added to the widget information list, enabling creation of the widget information list. It should be noted that the order of the widgets in the widget information list may be determined based on the order in which the developer adds the widgets.

Upon the developer triggers the operation of generating the target page, the computing device may determine that the widget information list corresponding to the target page is created.

The attribute information includes the types and position information of the widgets. In a possible implementation, the widget information list may be traversed to acquire the hierarchical relationship among the widgets in the generated target page. The position relationships among the widgets in the generated target page may be sequentially compared based on the types and the position information stored in the widget information list, to acquire the hierarchical relationship among the widgets.

It should be noted that the widgets may be categorized into stack widgets and non-stack widgets in terms of type. For the stack widgets, overlap between two stack widgets is allowed. However, it is not allowed for a non-stack widget to overlap with other widgets. Therefore, during the comparison of the position relationships among the widgets based on the types and the position information of the widgets, the types of two widgets currently being compared may be determined, and then the hierarchical relationship between the two widgets is determined based on the determined types of the two widgets and the position relationship between the two widgets.

As an example, the stack widget is a Stack container. For two Stack containers, if there is an overlap between the two Stack containers and one Stack container (denoted as “Stack container 1”) is completely included in the other Stack container (denoted as “Stack container 2”), it may be determined that the Stack container 2 is the root widget of the Stack container 1, and the Stack container 1 is the leaf widget of the Stack container 2. If there is an overlap between two Stack containers but one Stack container is not completely included in the other Stack container, it may be determined that the two Stack containers are of the same hierarchy and that the two Stack containers correspond to the same root widget. For two Stack containers without overlap therebetween, there is no need to determine the hierarchical relationship between the two Stack containers.

For the non-stack widgets, the process of determining the hierarchical relationship among the non-stack widgets will be described by taking the non-stack widgets as Containers, Row containers, and Column containers, as examples.

For a Container, only one widget may be included in the Container and the only one widget is also a Container in type. For two Containers, if one Container (denoted as “Container 1”) is completely included in the other Container (denoted as “Container 2”), it may be determined that the Container 2 is the root widget of the Container 1, and the Container 1 is the leaf widget of the Container 2. For two Containers with no inclusion relationship therebetween, there is no need to determine the hierarchical relationship between the two Containers.

For a Row container, a plurality of widgets arranged horizontally may be included in the Row container, and the plurality of widgets included in the Row container are also Row containers in type. For two Row containers, if one Row container (denoted as “Row container 1”) is completely included in the other Row container (denoted as “Row container 2”), it may be determined that the Row container 2 is the root widget of the Row container 1, and the Row container 1 is the leaf widget of the Row container 2. If there is no inclusion relationship between the two Row containers but the two Row containers are included in the same Row container, it may be determined that the two Row containers are of the same hierarchy and that the two Row containers correspond to the same root widget. For two Row containers that are not included in the same Row container, there is no need to determine the hierarchical relationship between the two Row containers.

For a Column container, a plurality of widgets arranged vertically may be included in the Column container, and the plurality of widgets included in the Column container are also Column containers in type. The process of determining the hierarchical relationship between two Column containers can be found in the above description of the Row container, and will not be repeated herein.

For ease of understanding, the process of determining the hierarchical relationship among the widgets will be described below in conjunction with a specific example. Referring to FIG. 6, FIG. 6 is a schematic page diagram illustrating a target page according to an embodiment of the present application. When determining the hierarchical relationship among widgets in the target page as shown in FIG. 6, the widgets may be traversed. When a widget 610 as a Container is traversed, it may be determined, by comparing the position relationship between the widget 610 and other widgets, that a widget 611 as a Container is completely included in the widget 610. Thus, it may be determined that the widget 610 is a root widget of the widget 611, and the widget 611 is a leaf widget of the widget 610. When a widget 620 as a Row container is traversed, it may be determined, by comparing the position relationship between the widget 620 and other widgets, that a widget 621 and a widget 622 as Row containers are both completely included in the widget 620 with no inclusion relationship therebetween. Thus, it may be determined that the widget 620 is a root widget of the widget 621 and the widget 622, the widget 621 and the widget 622 are both leaf widgets of the widget 620, and the widget 621 and the widget 622 are of the same hierarchy. When a widget 630 as a Column container is traversed, it may be determined, by comparing the position relationship between the widget 630 and other widgets, that a widget 631 and a widget 632 as Column containers are both completely included in the widget 630 with no inclusion relationship therebetween. Thus, it may be determined that the widget 630 is a root widget of the widget 631 and the widget 632, the widget 631 and the widget 632 are both leaf widgets of the widget 630, and the widget 631 and the widget 632 are of the same hierarchy. When a widget 640 as a Stack container is traversed, it may be determined, by comparing the position relationship between the widget 640 and other widgets, that a widget 641 and a widget 642 as Stack containers are both completely included in the widget 640 with overlap but no inclusion relationship therebetween. Thus, it may be determined that the widget 640 is a root widget of the widget 641 and the widget 642, the widget 641 and the widget 642 are both leaf widgets of the widget 640, and the widget 641 and the widget 642 are of the same hierarchy.

It should be noted that the position information of the widget may be represented with a parameter representation of a Rectangular (Rect) object. For example, the widget may be represented by a rectangular box, and the position of the widget may be recorded by recording positions of the leftmost point, the topmost point, the rightmost point, and the bottommost point of the rectangular box. In addition, the size of the widget may be determined by representing the position of the widget with the parameter representation of the Rect object, such that the comparison of the position relationship between the widgets may be realized based on the positions and sizes of the widgets.

Optionally, when traversing the widget information list, the first element in the widget information list may be used as a root element, which is denoted as curWidget. A template function is called to convert the View of the element curWidget (i.e., the attribute information corresponding to the element curWidget) into JavaScript Object Notation (JSON) strings, and set the type of the element curWidget in the JSON code based on the type of the widget corresponding to the element curWidget.

It should be noted that the type of the element curWidget may be categorized into single-Child type and multi-Child type. If the element curWidget is of the single-Child type, it indicates that the widget corresponding to the element curWidget is a root widget including only one leaf widget, such as a Container. If the element curWidget is of the multi-Child type, it indicates that the widget corresponding to the element curWidget is a root widget including a plurality of leaf widgets, such as Row container, Column container, or Stack container. That is, in the case that the widget corresponding to the element curWidget is a root widget including only one leaf widget, such as a Container, the element curWidget may be set as the single-Child type. In the case that the widget corresponding to the element curWidget is a root widget including a plurality of leaf widgets, such as Row container, Column container, or Stack container, the element curWidget may be set as the multi-Child type.

Optionally, in the case that the element curWidget is of the single-Child type, the JSON string used to define the type of the element curWidget may be set as child: @child. In the case that the element curWidget is of the multi-Child type, the JSON string used to define the type of the element curWidget may be set as children: [@child]. Moreover, the set JSON string may be denoted as parentString.

After the hierarchical relationship among the widgets in the target page is acquired in step 201, the attribute information of the widgets is acquired based on the hierarchical relationship among the widgets in step 202.

In some embodiments, when acquiring the attribute information of the widgets in the target page based on the hierarchical relationship among the widgets, the following steps 2021 and 2022 may be included.

At step 2021, one or more widget sets are generated based on the hierarchical relationship among the widgets, where each widget set includes a widget identifier of the first widget as the root widget as a keyword, and is configured to store a widget identifier of the second widget as the leaf widget corresponding to the root widget.

It should be noted that when the target page is generated based on the elements added to the canvas area by the developer, each of the elements added to the canvas area may be generated as a widget in the target page. The computing device, when generating the widgets in the target page, may generate a widget identifier for each of the widgets, such that each widget may be uniquely identified by the generated widget identifier. Optionally, the generated widget identifier may be a widget number determined according to the order in which the elements are added, or alternatively, the generated widget identifier may be a randomly generated string. The specific type of the widget identifier is not limited in the present application, as long as it is ensured that the widget identifiers of the widgets are different from each other.

In a possible implementation, for a root widget having at least one leaf widget, a widget identifier of the root widget may be used as a keyword to generate a mapping set, which is also known as a widget set, and values stored in the widget set indicate a widget identifier of the at least one leaf widget corresponding to the root widget.

It should be noted that there may be a root widget in the page, and all other widgets may be added to the root widget in the form of leaf widgets, in which case a widget set may be acquired. However, there may be a plurality of root widgets of the same hierarchy in the page, and each root widget has at least one leaf widget corresponding to that root widget, in which case a plurality of widget sets may be acquired, with different widget sets corresponding to different root widgets.

Still, the target page as shown in FIG. 6 is taken as an example. In the target page as shown in FIG. 6, there are four root widgets of the same hierarchy, namely, the widget 610, the widget 620, the widget 630, and the widget 640. Therefore, four widget sets may be acquired from the target page as shown in FIG. 6, with the four widget sets corresponding to different root widgets. For the convenience of description, the reference numeral of each widget in FIG. 6 is directly used as the widget identifier of each widget. Widget set 1 may be corresponding to the root widget 610, the keyword of the widget set 1 is 610, and the widget set 1 includes the widget identifier (i.e., 611) of the widget 611. Widget set 2 may be corresponding to the root widget 620, the keyword of the widget set 2 is 620, and the widget set 2 includes the widget identifier (i.e., 621) of the widget 621 and the widget identifier (i.e., 622) of the widget 622. Widget set 3 may be corresponding to the root widget 630, the keyword of the widget set 3 is 630, and the widget set 3 includes the widget identifier (i.e., 631) of the widget 631 and the widget identifier (i.e., 632) of the widget 632. Widget set 4 may be corresponding to the root widget 640, the keyword of the widget set 4 is 640, and the widget set 4 includes the widget identifier (i.e., 641) of the widget 641 and the widget identifier (i.e., 642) of the widget 642.

At step 2022, for any one of the widget sets, the attribute information of the first widget corresponding to the widget set and the attribute information of the second widget in the widget set are acquired.

Optionally, a widget identifier of a root widget corresponding to the root element curWidget may be acquired, and corresponding values, i.e., a widget identifier of at least one leaf widget included in a corresponding widget set, may be retrieved from the widget set based on the acquired widget identifier, and be recorded as a list childList. Subsequently, attribute information of a corresponding widget may be acquired based on the values recorded in the list childList, i.e., the widget identifier.

Further, a variable with a type of StringBuffer may be created, and a variable name of the created variable may be denoted as jsonBuffer, so as to encapsulate the list childList with the created variable jsonBuffer.

It should be noted that since the JSON string representing the type of the element curWidget has been denoted as parentString, the created variable jsonBuffer and the list childList encapsulated with the variable jsonBuffer may be recorded under the code declaring parentString, so as to indicate the type of widget corresponding to the created variable jsonBuffer and the list childList.

The attribute information includes at least position information. In the case that the attribute information is position information, for any one of the widget sets, acquiring the attribute information of the first widget corresponding to the widget set and the attribute information of the second widget in the widget set, may include the following steps 2022-1 and 2022-2.

At step 2022-1, for any widget set, the absolute position information of the first widget corresponding to the widget set is acquired.

At step 2022-2, in the case that the widget set is not empty, the relative position information of at least one second widget in the widget set is acquired based on the type of the first widget and the absolute position information of the at least one second widget.

It should be noted that the relative position information of leaf widgets is acquired in different ways for different types of root widgets (i.e., the first widget). Therefore, in the case that the list childList is not empty, the type of the parentString corresponding to the list childList (single-Child type or multi-Child type) may be determined, and thus the absolute position information of the second widget as the leaf widget is converted based on the determined type of the parentString corresponding to the list childList, so as to acquire the relative position information of the leaf widgets corresponding to different types of root widgets.

The process of acquiring the relative position information of the leaf widgets corresponding to different types of root widgets will be described below.

In a possible implementation, in the case that the first widget is a Container including only one second widget, position difference information of the second widget relative to the first widget is determined as the relative position information of the second widget based on the absolute position information of the first widget and the absolute position information of the second widget.

In the case of the widget represented by a rectangular box, if the first widget is a Container including only one leaf widget, the left (i.e., the leftmost point) and top (i.e., the topmost point) of the rectangular box of the leaf widget are compared directly with the left and top of the rectangular box of the root widget, respectively, to obtain a margin of the leaf widget relative to the root widget as the relative position information of the leaf widget.

In another possible implementation, in the case that the first widget is a Row container including a plurality of second widgets, the plurality of second widgets are sorted based on horizontal coordinate information of the plurality of second widgets, and the relative position information of the plurality of second widgets is determined based on the result of sorting of the plurality of second widgets, the absolute position information of the plurality of second widgets, and the absolute position information of the first widget.

It should be noted that if the first widget is a Row container in which a plurality of child elements may be included, the first widget may include a plurality of leaf widgets.

Optionally, when describing the relative position information of the plurality of leaf widgets in the Row container, the margin of the first leaf widget relative to the root widget may be used as the relative position information of the first leaf widget, while for a corresponding one of the second to the last leaf widget, the margin of the corresponding leaf widget relative to the previous leaf widget (to the left of and adjacent to the corresponding leaf widget) of the same hierarchy as the corresponding leaf widget may be used as the relative position information of the corresponding leaf widget.

Therefore, in the case that the first widget is a Row container, the plurality of second widgets corresponding to the first widget may be sorted in an ascending order of horizontal coordinates, so as to acquire the relative position information of each second widget based on the sorting results. The horizontal coordinate may be the horizontal coordinate of the leftmost point of each second widget.

It should be noted that, for the second widget with an order number of 1, the position difference information of the second widget with the order number of 1 relative to the first widget may be determined as the relative position information of the second widget with the order number of 1. For the second widget with the order number of N, the position difference information of the second widget with the order number of N relative to the second widget with the order number of N-1 may be determined as the relative position information of the second widget with the order number of N, where N is a positive integer not less than 2.

Optionally, an offset of the x-axis (horizontal axis) may be defined as xOffset, and an initial value of xOffset may be set to 0. The list childList is traversed. Difference values between the left (i.e., the horizontal coordinate of the leftmost point, the same below) and top (i.e., the vertical coordinate of the topmost point, the same below) of the rectangular box of the leaf widget with the order number of 1 and the left and top of the rectangular box of the root widget are calculated, respectively, and then xOffset is subtracted from the difference value for the left to obtain the margin of the leaf widget with the order number of 1 in the horizontal axis, and the difference value between the top of the rectangular box of the leaf widget with the order number of 1 and the top of the rectangular box of the root widget is used as the margin of the leaf widget with the order number of 1 in the vertical axis. The left of the rectangular box of the leaf widget with the order number of 1 plus a width of the rectangular box of the leaf widget with the order number of 1 is assigned to xOffset so as to update xOffset for the first time. xOffset updated for the first time is subtracted from the left of the rectangular box of the leaf widget with the order number of 2 to obtain the margin of the leaf widget with the order number of 2 in the horizontal axis, and the difference value between the top of the rectangular box of the leaf widget with the order number of 2 and the top of the rectangular box of the root widget is used as the margin of the leaf widget with the order number of 2 in the vertical axis. The left of the rectangular box of the leaf widget with the order number of 2 plus a width of the rectangular box of the leaf widget with the order number of 2 is assigned to xOffset so as to update xOffset for the second time, and so on, enabling determination of the relative position information of the plurality of second widgets.

In another possible implementation, in the case that the first widget is a Column container including a plurality of second widgets, the plurality of second widgets are sorted based on vertical coordinate information of the plurality of second widgets, and the relative position information of the plurality of second widgets is determined based on the result of sorting of the plurality of second widgets, the absolute position information of the plurality of second widgets, and the absolute position information of the first widget.

It should be noted that if the first widget is a Column container in which a plurality of child elements may be included, the first widget may include a plurality of leaf widgets. When describing the relative position information of the plurality of leaf widgets in the Column container, the margin of the first leaf widget is relative to the root widget, while the margin of a corresponding one of the second to the last leaf widget is relative to the previous leaf widget (above and adjacent to the corresponding leaf widget) of the same hierarchy as the corresponding leaf widget.

Therefore, in the case that the first widget is a Column container, the plurality of second widgets corresponding to the first widget may be sorted in an ascending order of vertical coordinates, so as to acquire the relative position information of each second widget based on the sorting results. The vertical coordinate may be the vertical coordinate of the topmost point of each second widget.

It should be noted that, for the second widget with the order number of 1, the position difference information of the second widget with the order number of 1 relative to the first widget may be determined as the relative position information of the second widget with the order number of 1. For the second widget with the order number of N, the position difference information of the second widget with the order number of N relative to the second widget with the order number of N-1 may be determined as the relative position information of the second widget with the order number of N, where N is a positive integer not less than 2.

Optionally, an offset of the y-axis (vertical axis) may be defined as yOffset, and an initial value of yOffset may be set to 0. The list childList is traversed. Difference values between the left (i.e., the horizontal coordinate of the leftmost point, the same below) and top (i.e., the vertical coordinate of the topmost point, the same below) of the rectangular box of the leaf widget with the order number of 1 and the left and top of the rectangular box of the root widget are calculated, respectively, and then yOffset is subtracted from the difference value for the top to obtain the margin of the leaf widget with the order number of 1 in the vertical axis, and the difference value between the left of the rectangular box of the leaf widget with the order number of 1 and the left of the rectangular box of the root widget is used as the margin of the leaf widget with the order number of 1 in the horizontal axis. The top of the rectangular box of the leaf widget with the order number of 1 plus a width of the rectangular box of the leaf widget with the order number of 1 is assigned to yOffset so as to update yOffset for the first time. yOffset updated for the first time is subtracted from the top of the rectangular box of the leaf widget with the order number of 2 to obtain the margin of the leaf widget with the order number of 2 in the vertical axis, and the difference value between the left of the rectangular box of the leaf widget with the order number of 2 and the left of the rectangular box of the root widget is used as the margin of the leaf widget with the order number of 2 in the horizontal axis. The top of the rectangular box of the leaf widget with the order number of 2 plus a width of the rectangular box of the leaf widget with the order number of 2 is assigned to yOffset so as to update yOffset for the second time, and so on, enabling determination of the relative position information of the plurality of second widgets.

In another possible implementation, in the case that the first widget is a Stack container including a plurality of second widgets, position difference information of each of the second widgets relative to the first widget is determined as the relative position information of each second widget based on the absolute position information of the first widget and the absolute position information of each second widget.

It should be noted that if the first widget is a Stack container in which a plurality of child elements may be included, the first widget may include a plurality of leaf widgets. When describing the relative position information of the plurality of leaf widgets in the Stack container, the margin of each of the leaf widgets is relative to the root widget.

Therefore, in the case that the first widget is a Stack container, the list childList may be traversed. Difference values between the left and top of the rectangular box of the leaf widget currently traversed and the left and top of the rectangular box of the root widget may be calculated respectively as margins of the leaf widget currently traversed.

Acquisition of the relative position information of the second widget in the case that the widget set is not empty has been mainly described above, while in the case that the widget set is empty, which indicates that no second widget is included in the corresponding first widget, there is no need to acquire the relative position information of the second widget. Optionally, in the case that the widget set is empty, that is, the list childList is empty, parentString may be returned directly.

With the above process, the absolute position information of the first widget and the relative position information of the second widget may be acquired. Compared to use of the absolute position information to describe the page layout, use of the relative position information to describe the page layout can be applied universally in the page visualization configuration process and the page development process. Therefore, the relative position information has a higher readability than the absolute position information, such that the readability of the generated descriptive language file can be improved, and thus the readability of other files converted from the descriptive language file can be improved.

After the absolute position information of the first widget and the relative position information of the second widget are acquired, the descriptive language file for the target page is generated based on the attribute information of the widgets in step 203.

In some embodiments, generating the descriptive language file for the target page based on the attribute information of the widgets in step 203, may include the following steps 2031 and 2032.

At step 2031, a plurality of strings in a first preset format are generated based on the attribute information of the widgets, where the strings describe the attribute information according to a format requirement of the first preset format.

The string in the first preset format may be a JSON string, which is of a universal lightweight data exchange format. By generating the descriptive language file based on the JSON strings, the parsing and format conversion of the descriptive language file are made easier, thereby improving the page development efficiency.

Optionally, each time relative position information of a second widget is acquired, a template function may be called to generate a JSON string for describing the relative position information of the second widget. In this way, a plurality of JSON strings, that is, the plurality of strings in the first preset format, may be obtained. It should be noted that the JSON string may be denoted as childString.

At step 2032, the descriptive language file is generated based on the plurality of strings in the first preset format.

Optionally, when the descriptive language file is generated based on the plurality of strings in the first preset format, the descriptive language file may be generated based on the number of the leaf widgets included in the widget set, that is, a length of the list childList.

If the length of the list childList is 1, the string @child in the string parentString may be replaced with a string parentString2, and the widget identifier of the leaf widget included in the list childList is recorded as list childList2. In this case, because the length of the list childList is 1, there is only one leaf widget in the root widget, and there are no other widgets in the leaf widget. In addition, due to the limitation of the widget layout requirements, no more widgets are to be included in the leaf widget. Therefore, the list childList2 is empty, and the string parentString2 may be returned directly.

If the length of the list childList is greater than 1, indicating that more than one leaf widget is included in the root widget, the widget identifier of each leaf widget in the list childList may be recorded as list childList 2. However, due to the limitation of the widget layout requirements, no more widgets are to be included in each leaf widget. Therefore, the list childList2 is empty, so the string childString may be returned directly. Optionally, a value of the returned string childString may be written in jsonBuffer.

With the above process, a plurality of values of the variable jsonBuffer may be acquired, which is equivalent to obtaining a jsonBuffer byte stream. If the jsonBuffer byte stream is not empty, the jsonBuffer byte stream may be converted into a string jsonBufferString, and the string @child in the string parentString may be replaced with the string jsonBufferString.

At this point, the attribute information of the target page can be converted into a corresponding DSL descriptive language to obtain a DSL file as the descriptive language file.

The DSL file may be parsed through a DSL4.0 parsing framework. The developer may view the configured page information in real time and make modifications to the configured page through a web browser based on the parsed DSL file. The modifications made by the developer may be synchronized by refreshing the page after modification.

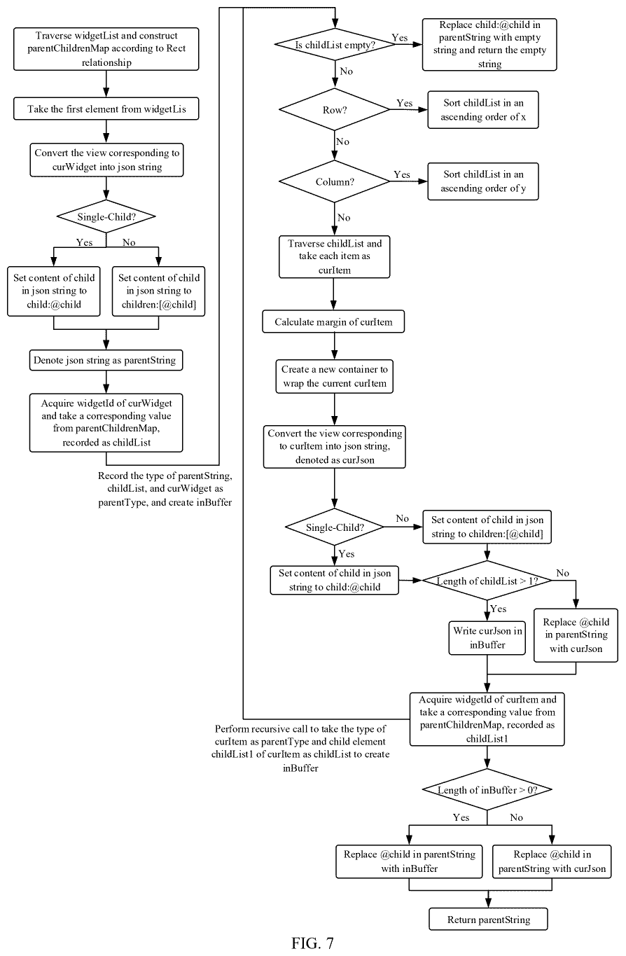

Referring to FIG. 7, FIG. 7 is a flowchart illustrating a page processing method according to an embodiment of the present application. As shown in FIG. 7, after a list widgetList (i.e., a widget information list) is acquired, the list widgetList may be traversed to determine a hierarchical relationship among widgets based on the attribute information of the widgets represented by Rect objects, so as to construct a parentChildrenMap (i.e., a widget set) according to the determined hierarchical relationship. The first element is taken from the list widgetList and is denoted as curWidget, so as to convert the view corresponding to the element curWidget into a JSON string. In turn, subsequent processes are performed based on the type of the element curWidget. In the case that the element curWidget is of a single-Child type, the JSON string that indicates the type of the element curWidget may be set to child:@child. In the case that the element curWidget is of a multi-Child type, the JSON string that indicates the type of the element curWidget may be set to children:[@child]. In either case, the JSON string may be denoted as parentString after the JSON string is set. After parentString is acquired, a widget identifier widgetId of the element curWidget may be acquired. A value corresponding to the identifier widgetId in the parentChildrenMap is recorded as a list childList. Thus, the type of parentString, childList, and curWidget is recorded as parentType, and inBuffer is created. After creating inBuffer, it may be determined firstly whether the list childList is empty or not. If the list childList is empty, child:@child in the string parentString may be replaced with an empty string and the empty string is returned. If the list childList is not empty, different processes may be performed based on parentType. If parentType is Row (that is, Row container), the list childList may be sorted in an ascending order of x coordinates. If parentType is Column (that is, Column container), the list childList may be sorted in an ascending order of y coordinates. If parentType is neither Row nor Column, the list childList may be traversed. Each item in the list childList is taken as curltem, and a margin of the item curItem is calculated. Thus, a new container is created and wraps the current item curItem, and then the view corresponding to the item curItem is converted into a JSON string, which is denoted as curJson. If the newly created container is of a single-Child type, the content of child in the JSON string may be set to child:@child. If the newly created container is of a multi-Child type, the content of child in the JSON string may be set to children:[@child]. In either case, after the content of child in the JSON string is set, it is necessary to determine whether a length of the list childList is greater than 1 or not. If the length of the list childList is greater than 1, curJson may be written in inBuffer; otherwise, @child in the string parentString is replaced with curJson. An identifier widgetId of the item curltem may be acquired either after writing curJson in inBuffer or after replacing @child in the string parentString with curJson. The value corresponding to the identifier widgetId in the parentChildrenMap is recorded as childList1,and then a recursive call is performed to take the type of the item curltem as parentType, the child element childList1 of the item curItem is taken as childList to create inBuffer, and then the above process after creating inBuffer is repeated. If a length of inBuffer is greater than 0, @child in the string parentString may be replaced with the string inBuffer, and if the length of inBuffer is not greater than 0, @child in the string parentString may be replaced with curJson to return the string parentString. With the above process, the attribute information of the widget may be described in the JSON language, thus enabling the generation of the descriptive language file.

The process of acquiring the descriptive language file has been mainly described above. In more possible implementations, the descriptive language file may also be converted into a source code (Dart) file. Further, the developer may synchronize the converted Dart source code directly to a corresponding code repository through the Jenkins backend.

Dart is a computer programming language developed by Google that can be run directly by a computer. A file written in the Dart language is a Dart file. By converting the descriptive language file into the Dart file, the computer can directly compile the Dart file to run the Dart code in the Dart file, thereby enabling the display of the target page.

A code repository, also known as a repository, resource repository, version repository, code database, or depository, is a public or private place where a large amount of source code is stored. Most repositories are used for backups and version control, and to help handle various code versioning issues in multi-developer projects. By synchronizing the Dart source code to the code repository, developers involved in the same project can access the Dart source code, such that different developers can view or modify it.

In some embodiments, a source code acquisition widget may be provided in the page development platform, such that the developer can convert the descriptive language file into the source code file by triggering the source code acquisition widget.

In a possible implementation, the descriptive language file may be parsed and format conversion may be performed on the descriptive language file to convert the descriptive language file into the source code file, in response to a trigger operation on the source code acquisition widget.

It should be noted that in the related art, only one page is generally created for each project, such that each project includes only one item (one page corresponds to one item). In contrast, the present application adds the concept of a directory to a single project of the page development platform. Based on the concept of the directory, the developer, after creating a project, can create a plurality of directories for the project, and create a page under the plurality of directories, so as to achieve the effect of categorizing and storing the page through the directories. Moreover, in an item corresponding to each page, the developer can configure a jump operation between that page and other pages, so as to enable jumping between the pages.

On the basis of this, in some embodiments, parsing and performing format conversion on the descriptive language file to convert the descriptive language file into the source code file, in response to the trigger operation on the source code acquisition widget, may include the following steps I and II.

At step I, a directory list is acquired in response to the trigger operation on the source code acquisition widget, where the directory list includes a plurality of items each of which includes a subdirectory and/or the descriptive language file.

It should be noted that the directory list can be denoted as folderList. The directory list may include a plurality of items each of which may include a descriptive language file and/or a subdirectory, where the subdirectory may further include at least one descriptive language file.

For example, a directory list may include a DSL file 1, a DSL file 2, a subdirectory 1, and a subdirectory 2. The subdirectory 1 may include a DSL file 3, and the subdirectory 2 may include a DSL file 4 and a DSL file 5. The DSL files in the directory list each correspond to a project created by a user at the beginning of the page development.

Optionally, before the directory list is acquired in response to the trigger operation on the source code acquisition widget, it may be determined whether each page for the current project has been converted into the descriptive language file. If there are unconverted pages, the unconverted pages may be converted into descriptive language files through the above embodiments. In the case that each page has been converted into the descriptive language file, the directory list is acquired in response to the trigger operation on the source code acquisition widget.

At step II, for any one of the items in the directory list, if the item includes the descriptive language file, the descriptive language file is parsed and format conversion is performed on the descriptive language file to convert the descriptive language file into the source code file, and if the item includes the subdirectory, the descriptive language file is acquired from the subdirectory, and the descriptive language file is parsed and format conversion is performed on the descriptive language file to convert the descriptive language file into the source code file.

In a possible implementation, the descriptive language file may be parsed and format conversion may be performed on the descriptive language file to convert the descriptive language file into the source code file in the following manner.

For any first widget in the descriptive language file, based on the type of the first widget, format conversion is performed on strings of the first widget and at least one second widget corresponding to the first widget in the descriptive language file to obtain strings in a second preset format. The source code file is generated based on the strings in the second preset format.

Optionally, the directory list folderList may be recursively traversed, and it is determined whether the currently traversed item is a file or a directory. In the case that the currently traversed item is the directory, a folder may be created according to the set name of the directory, and then at least one descriptive language file may be retrieved from the directory to perform subsequent processes based on the descriptive language file. In the case that the currently traversed item is the file, the subsequent processes may be performed directly based on the descriptive language file.

A plurality of descriptive language files are recursively traversed, and each time a descriptive language file is traversed, widgets in the descriptive language file may be processed in sequence. Optionally, the type of the current widget to be parsed may be determined, so as to acquire the source code corresponding to the widget based on the determined type of the widget. Different types of widgets may correspond to different source code templates, such that codes corresponding to the widgets may be acquired based on corresponding source code templates.

If the widget is a Container, which includes only one element (corresponding to one leaf widget), and the source code template for the Container is a container template, a margin string for the element may be acquired from the descriptive language file, and a template engineering method is called to convert the margin string into a margin string for a margin object in the Dart language, for which a variable name may be set and is denoted as EdgMargin. Objects indicating a width and height of the element may also be acquired from the descriptive language file, and the template engineering method is called to convert the objects into a width-height string in the Dart language, which is denoted as widthHeight. A decoration object of the element may also be acquired from the descriptive language file, and the template engineering method is called to convert the decoration object into a decoration string decorationString in the Dart language. Then the template engineering method is called to replace string @margin for a margin object in the container template with EdgMargin, replace string @width for the object indicating the width of the element and string @height for the object indicating the height of the element with the string widthHeight, and replace string @decoration for the decoration object with the string decorationString.

Further, it may be determined whether the element has a child element. If the element has no child element, the string @child may be replaced with a string SizedBox( ) If the element has a child element, the widget type of the child object may be determined in a manner similar to the above process, and then the DSL descriptive language corresponding to the child object is converted into a source code based on the determined widget type, and the string @child in the container template is replaced with the converted string.

If the widget is a Column container or a Row container, both of which include a plurality of elements, the plurality of elements may be processed in sequence. Optionally, layout strings of a main axis and a cross axis corresponding to the currently processed element (that is, the relative position information of the widget corresponding to the currently processed element) may be acquired from the descriptive language file, and the template engineering method is called to convert the layout strings into the descriptive text of the layout of the main axis and the cross axis in the Dart language, which may be recorded as variables mainAxisString and crossAxisString. Then the template engineering method is called to replace a string @mainAxis for the variable mainAxisString in a source code template of the Column container or Row container with a string mainAxisString, and replace a string @crossAxis for the variable cross AxisString with crossAxisString.

Further, it may be determined whether the element has a child element. If the element has no child element, the string @child may be replaced with a string SizedBox( ) If the element has a child element, the widget type of each object in the children list may be determined in a manner similar to the above process, and then the DSL descriptive language corresponding to each object in the children list is converted into a source code based on the determined widget type, and the string @child in the source code template is replaced with the converted string.

If the widget is a Stack container which includes a plurality of elements, for any one of the elements, it may be determined whether the element has a child element. If the element has no child element, the string @child may be replaced with a string SizedBox( ) If the element has a child element, the widget type of each object in the children list may be determined in a manner similar to the above process, and then the DSL descriptive language corresponding to each object in the children list is converted into a source code based on the determined widget type, and the string @child in the source code template is replaced with the converted string.

If the widget is a text view widget, and the source code template for the text widget is a text template, a text information string configured for the widget (that is, text characters to be displayed in the widget) may be acquired from the descriptive language file, and is recorded as dataString. A style object configured for the widget may also be acquired from the descriptive language file, and is converted into a string which may be recorded as styleString. Then, the template engineering method is called to replace string @data in the text template with the string dataString, and replace string @style in the text template with the string styleString.

If the widget is an image view widget, and the source code template for the image widget is also a text template, an image address information string configured for the widget may be acquired from the descriptive language file, and is recorded as urlString. Width and height objects configured for the widget may also be acquired from the descriptive language file, and are converted into strings which may be recorded as widthString and heightString. Then, the template engineering method is called to replace string @url in the text template file with the string urlString, replace string @width in the text template file with the string widthString, and replace string @height in the text template file with heightString.

With the above process, contents in the descriptive language file may be converted into Dart source code strings, which may be recorded as pageString. Further, the template engineering method may be called to replace the string @child in the page template with pageString. At this point, a complete Dart source code string is generated, and then a.dart file is created with the configured class name, and the source code string is written into this.dart file to obtain the source code file corresponding to the descriptive language file.

It should be noted that after the directory has been traversed, a directory with multiple layers may be obtained, with each layer corresponding to a source code file. The obtained source code files may be compressed and packaged to a preset address, and a download address is returned to the developer based on the preset address. The developer may download the compressed and packaged source code files to the local through the download address, so as to perform the secondary development on the page at the source code level based on the downloaded source code files.

Optionally, the above process is illustrated in the case that the download of the source code files is triggered through the source code acquisition widget. In more possible implementations, the developer may perform source code conversion through a visual WEB tool service. The visual WEB tool service may be a Jenkins service.

In a possible implementation, a project identifier corresponding to the descriptive language file may be acquired from a target platform, a directory list corresponding to the descriptive language file may be acquired based on the project identifier, and the directory list may be added to a preset directory to obtain an executable program file.

For example, the developer may open a Jenkins service, enter an identifier of a project into the Jenkins service, and trigger a source code build process. The Jenkins service may acquire a descriptive language file of the project through the identifier, and then parse the descriptive language file to obtain configuration information of the project, so as to traverse a directory structure of the project to obtain a directory with multiple layers (that is, a directory list). In this way, conversion from DSL descriptive language to source code is realized.

Optionally, the developer may pre-set a Git repository address to indicate which Git repository the generated source code file is to be stored in.

If the Git repository address does not correspond to an empty repository, repository information may be pulled to copy the created directory to a Lib directory, which modification is then submitted to the repository. If the Git repository address corresponds to an empty repository, an address of a preset template project may be pulled to copy the created directory to a Lib directory of the template project, which modification is then submitted to the repository.

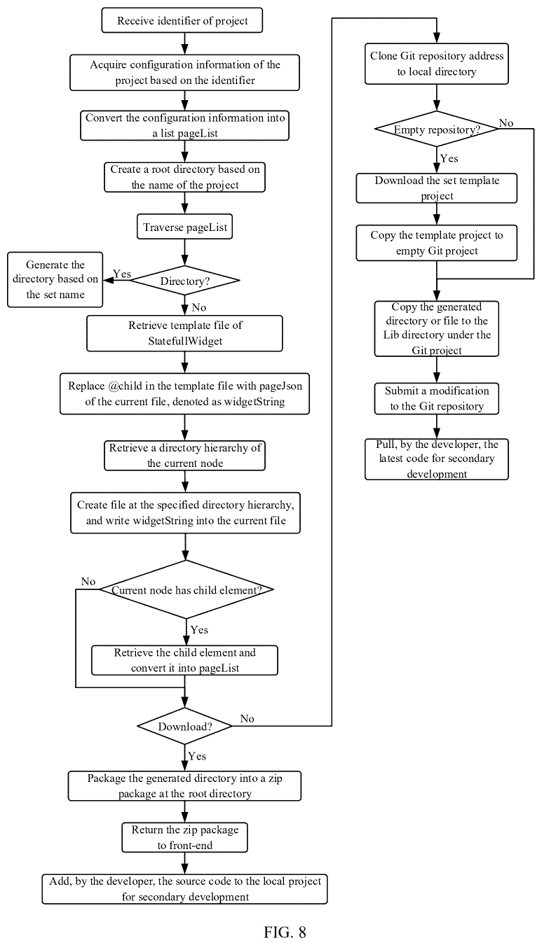

Referring to FIG.8, FIG. 8 is a flowchart illustrating a process of acquiring a source code file according to an embodiment of the present application. As shown in FIG. 8, after an identifier of a project is acquired, configuration information of the project may be acquired based on the identifier, so as to convert the configuration information into a list pageList and create a root directory based on the name of the project. The list pageList is traversed. If a directory is traversed, the directory may be generated based on the set name. If it is not a directory, a template file of StatefullWidget may be retrieved, and the string @child in the template file is replaced with a string pageJson of the current file, which may be denoted as widgetString. Thus, a directory hierarchy of the current node is retrieved, a file is created at the specified directory hierarchy, and widgetString is written into the current file. Then it is determined whether the current node has a child element, if so, the child element may be retrieved and converted into a list pageList, which is continued to be traversd.

If the developer chooses to directly download the source code file, the generated directory may be packaged into a compressed package (that is, a zip package) at the root directory to enable access to the source code file. The zip package is returned to the front-end, such that the developer may add the source code file to the local project for secondary development. If the developer does not choose to directly download the source code file, the pre-passed Git repository address may be cloned to a local directory. If the Git repository address corresponds to an empty repository, the set template project may be downloaded and the template project may be copied to the empty Git project, and then the generated directory or file is copied to the Lib directory under the Git project. If the Git repository address does not correspond to an empty repository, the generated directory or file is directly copied to the Lib directory under the Git project. After copying the generated directory or file to the Lib directory under the Git project, a modification may be submitted to the repository, such that the developer may pull the latest code from the repository for secondary development.

In more possible implementations, executable program products (i.e., executable program files) for the mobile or Windows side may also be obtained from the descriptive language file.

In a possible implementation, a project identifier corresponding to the descriptive language file and a version of a device corresponding to an executable program file to be generated may be acquired from the target platform, thereby generating the executable program file based on the project identifier and the version of the device.

For example, after saving the configured page, the user may enter the corresponding project identifier in the Jenkins management backend, and select a corresponding version of a terminal to be applied. The Jenkins management backend may build apk files for the mobile side or exe executable files for the Windows side, so as to obtain executable program products for the mobile or Windows side.

Corresponding to the embodiments of the above method, the present application further provides embodiments of a page processing apparatus and a computing device to which the page processing apparatus is applied.

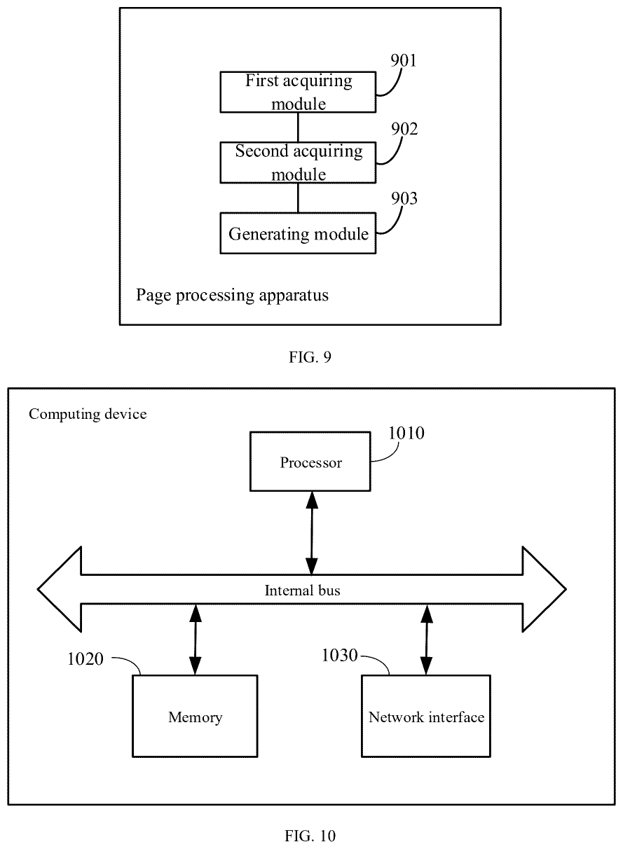

As shown in FIG. 9, FIG. 9 is a block diagram illustrating a page processing apparatus according to an embodiment of the present application. The apparatus includes a first acquiring module 901, a second acquiring module 902, and a generating module 903.

The first acquiring module 901 is configured to in response to an operation of generating a target page in a page development platform, acquire a hierarchical relationship among widgets in the target page.

The second acquiring module 902 is configured to acquire attribute information of the widgets based on the hierarchical relationship, where the attribute information includes absolute position information of a first widget among the widgets as a root widget and relative position information of a second widget among the widgets as a leaf widget.

The generating module 903 is configured to generate a descriptive language file for the target page based on the attribute information.

In some embodiments, when acquiring the attribute information of the widgets based on the hierarchical relationship, the second acquiring module 902 is configured to:
generate one or more widget sets based on the hierarchical relationship, where each widget set of the one or more widget sets includes a widget identifier of the first widget as a keyword, and is configured to store a widget identifier of the second widget; and
acquire, for any widget set of the one or more widget sets, the attribute information of the first widget corresponding to the widget set and the attribute information of the second widget in the widget set.

In some embodiments, in the case that the attribute information is position information, when acquiring the attribute information of the first widget corresponding to the widget set and the attribute information of the second widget in the widget set, the second acquiring module 902 is configured to:
acquire, for any widget set, the absolute position information of the first widget corresponding to the widget set; and
in the case that the widget set is not empty, acquire the relative position information of at least one second widget in the widget set based on a type of the first widget and the absolute position information of the at least one second widget.

In some embodiments, when acquiring the relative position information of the at least one second widget in the widget set, the second acquiring module 902 is configured to perform any one of the following operations.

If the first widget is a container including only one second widget, position difference information of the second widget relative to the first widget is determined as the relative position information of the second widget based on the absolute position information of the first widget and the absolute position information of the second widget.

If the first widget is a stack container including a plurality of second widgets, position difference information of each of the second widgets relative to the first widget is determined as the relative position information of each second widget based on the absolute position information of the first widget and the absolute position information of each second widget.

In some embodiments, when acquiring the relative position information of the at least one second widget in the widget set, the second acquiring module 902 is further configured to perform any one of the following operations.

If the first widget is a row container including a plurality of second widgets, the plurality of second widgets are sorted in an ascending order of horizontal coordinates of the plurality of second widgets, and the relative position information of the plurality of second widgets is determined based on the result of sorting of the plurality of second widgets, the absolute position information of the plurality of second widgets, and the absolute position information of the first widget.

If the first widget is a column container including a plurality of second widgets, the plurality of second widgets are sorted in an ascending order of vertical coordinates of the plurality of second widgets, and the relative position information of the plurality of second widgets is determined based on the result of sorting of the plurality of second widgets, the absolute position information of the plurality of second widgets, and the absolute position information of the first widget.

In some embodiments, when determining the relative position information of the plurality of second widgets based on the result of sorting of the plurality of second widgets, the absolute position information of the plurality of second widgets, and the absolute position information of the first widget, the second acquiring module 902 is configured to:
for the second widget with an order number of 1, determine the position difference information of the second widget with the order number of 1 relative to the first widget as the relative position information of the second widget with the order number of 1; and
for the second widget with the order number of N, determine the position difference information of the second widget with the order number of N relative to the second widget with the order number of N-1 as the relative position information of the second widget with the order number of N, where N is a positive integer not less than 2.

In some embodiments, when generating the descriptive language file for the target page based on the attribute information, the generating module 903 is configured to:
generate a plurality of strings in a first preset format based on the attribute information of the widgets, where the strings are configured to describe the attribute information according to a format requirement of the first preset format; and
generate the descriptive language file based on the plurality of strings in the first preset format.

In some embodiments, when acquiring the hierarchical relationship among the widgets in the target page, the first acquiring module 901 is configured to:
in response to an operation of adding the widgets in the page development platform, display the target page based on the widgets added in the page development platform; and
acquire the hierarchical relationship among the widgets in the target page, in response to the operation of generating the target page.

In some embodiments, when acquiring the hierarchical relationship among the widgets in the target page, the first acquiring module 901 is configured to:
determine the hierarchical relationship among the widgets in the target page based on a type and position information of each of the widgets in the target page.

In some embodiments, when determining the hierarchical relationship among the widgets in the target page based on the type and the position information of each of the widgets in the target page, the first acquiring module 901 is configured to:
traverse the widgets in the target page, and for each widget currently traversed, determine the hierarchical relationship among the each widget currently traversed and the other widgets in the target page based on the type of the each widget currently traversed and the position relationship among the each widget currently traversed and the other widgets.

In some embodiments, the page development platform includes a source code acquisition widget.

The apparatus further includes a conversion module.

The conversion module is configured to parse and perform format conversion on the descriptive language file to convert the descriptive language file into a source code file, in response to a trigger operation on the source code acquisition widget.

In some embodiments, when parsing and performing format conversion on the descriptive language file to convert the descriptive language file into the source code file, the conversion module is configured to:
acquire a directory list in response to the trigger operation on the source code acquisition widget, where the directory list includes a plurality of items, each of which includes a subdirectory and/or the descriptive language file; and
for any one of the items in the directory list that includes the descriptive language file, parse and perform format conversion on the descriptive language file to convert the descriptive language file into the source code file, and for any one of the items in the directory list that includes the subdirectory, acquire the descriptive language file from the subdirectory, and parse and perform format conversion on the descriptive language file to convert the descriptive language file into the source code file.

In some embodiments, when parsing and performing format conversion on the descriptive language file to convert the descriptive language file into the source code file, the conversion module is configured to:
for any first widget in the descriptive language file, perform format conversion on strings of the first widget and at least one second widget corresponding to the first widget in the descriptive language file based on a type of the first widget, to obtain strings in a second preset format; and
generate the source code file based on the strings in the second preset format.

In some embodiments, the apparatus further includes a third acquiring module.

The third acquiring module is configured to acquire, from a target platform, a project identifier corresponding to the descriptive language file and a version of a device corresponding to an executable program file to be generated.

The generating module 903 is further configured to generate the executable program file based on the project identifier and the version of the device.

For the apparatus embodiments, since they basically correspond to the method embodiments, relevant portions can be found in part of the description of the method embodiments. The above-described apparatus embodiments are merely exemplary in that the modules illustrated as separate components may or may not be physically separated, and the components shown as modules may or may not be physical modules, i.e., may be located in one place, or may be distributed over multiple network modules. Some or all of the modules may be selected according to actual needs to achieve the purpose of the solutions in the present specification. Those ordinary skilled in the art can understand and implement it without creative efforts.

The present application further provides a computing device. Referring to FIG. 10, FIG. 10 is a schematic structural diagram illustrating a computing device according to an embodiment of the present application. As shown in FIG. 10, the computing device includes a processor 1010, a memory 1020, and a network interface 1030. The memory 1020 is configured to store computer instructions executable on the processor 1010. The processor 1010 is configured to implement the page processing method according to any one of the embodiments in the present application when executing the computer instructions. The network interface 1030 is configured to implement input and output functions. In more possible implementations, the computing device may also include other hardware, which is not limited in the present application.

The present application further provides a non-transitory computer-readable storage medium. The computer-readable storage medium can be in various forms. For example, in various examples, the computer-readable storage medium can be RAM (Random Access Memory), volatile memory, non-volatile memory, flash memory, storage drive (e.g., hard disk drive), solid state drive, any type of storage disk (e.g., CD, DVD, etc.), or the like, or a combination thereof. In particular, the computer-readable medium may be paper or another suitable medium on which programs can be printed. The computer-readable storage medium stores a computer program, which, when executed by a processor, implements the page processing method according to any one of the embodiments in the present application.

The present application further provides a computer program product, including a computer program, which, when executed by a processor, implements the page processing method according to any one of the embodiments in the present application.

As will be appreciate by those skilled in that art, one or more embodiments in the present specification may be provided as a method, apparatus, computing device, computer-readable storage medium, or computer program product. Accordingly, one or more embodiments in the present specification may be in the form of an entirely hardware embodiment, an entirely software embodiment, or an embodiment combining software and hardware aspects. Furthermore, one or more embodiments in the present specification may be in the form of a computer program product embodied in one or more computer-usable storage media having computer-usable program code therein, including but not limited to magnetic disk storage, CD-ROM, optical storage, etc.

Various embodiments in this specification are described in a progressive manner, the same or similar parts between various embodiments can be referred to each other, and each embodiment focuses on differences from other embodiments. In particular, for the embodiments corresponding to the computing device, since they are basically similar to the method embodiments, the description thereof is relatively simple, and relevant portions can be found in part of the description of the method embodiments.

Specific embodiments in the present specification have been described above. Other embodiments are within the scope of the present application. In some cases, actions or steps recited in the present application may be performed in a different order than in the embodiments and still achieve desirable results. In addition, the processes depicted in the drawings do not necessarily require the particular order or consecutive order shown to achieve the desirable results. Multitasking and parallel processing are also possible or may be advantageous in some embodiments.

Embodiments of the subject matter and functional operations described in this specification can be implemented in digital electronic circuitry, tangibly embodied computer software or firmware, computer hardware including the structures disclosed in this specification and structural equivalents thereof, or a combination of one or more thereof. Embodiments of the subject matter described in this specification can be implemented as one or more computer programs, i.e., one or more modules of computer program instructions encoded on a tangible non-transitory program carrier for execution by, or to control the operation of, the page processing apparatus. Alternatively or additionally, the program instructions may be encoded on an artificially generated propagation signal, such as a machine-generated electrical, optical, or electromagnetic signal, that is generated to encode and transmit the information to a suitable receiver apparatus for execution by the page processing apparatus. Computer storage media may be machine-readable storage devices, machine-readable storage substrates, random or serial access memory devices, or a combination of one or more thereof.

The processes and logic flows described in this specification can be performed by one or more programmable computers executing one or more computer programs to perform corresponding functions by operating on input data and generating outputs. The processes and logic flows may also be performed by special purpose logic circuitry, such as FPGA (Field Programmable Gate Array) or ASIC (Application Specific Integrated Circuit), and apparatuses may also be implemented as special purpose logic circuitry.

Computers suitable for executing computer programs include, for example, general purpose and/or special purpose microprocessors, or any other type of central processing units. Typically, the central processing unit may receive instructions and data from a read-only memory and/or a random access memory. The basic components of a computer include a central processing unit for implementing or executing instructions and one or more memory devices for storing instructions and data. Generally, a computer may also include, or be operatively coupled to receive data from or transmit data to, or both, one or more mass storage devices for storing data, such as magnetic disks, magneto-optical disks, or optical disks. However, it is not necessary for a computer to have such a device. In addition, a computer may be embedded in another device, such as a mobile phone, a personal digital assistant (PDA), a mobile audio or video player, a game console, a global positioning system (GPS) receiver, or a portable storage device such as a universal serial bus (USB) flash drive, to name a few.

Computer-readable media suitable for storing computer program instructions and data include all forms of non-volatile memory, media, and memory devices, including, for example, semiconductor memory devices (e.g., EPROMs, EEPROMs, and flash memory devices), magnetic disks (e.g., internal hard disks or removable disks), magneto-optical disks, and CD ROM and DVD-ROM disks. Processors and memories may be supplemented by or incorporated into special purpose logic circuitry.

While this specification contains many specific implementation details, these should not be construed as limiting the scope of any invention or the claimed scope, but are primarily intended to describe the features of specific embodiments of a particular invention. Certain features described in multiple embodiments in this specification may also be implemented in combination in a single embodiment. On the other hand, various features described in a single embodiment may also be implemented separately in multiple embodiments or in any suitable sub-combination. Moreover, while the features may function in certain combinations as described above and even initially claimed as such, one or more features from a claimed combination may in some cases be excised from the combination and the claimed combination may be directed to a sub-combination or variation of a sub-combination.

Similarly, while operations are depicted in the drawings in a particular order, this should not be understood as requiring that such operations be performed in the particular order shown or sequentially, or that all illustrated operations be performed, to achieve desirable results. In some cases, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, specific embodiments of the subject matter have been described. Other embodiments are within the scope of the present application. In some cases, actions described herein may be performed in a different order and still achieve desirable results. Moreover, the processes depicted in the drawings do not necessarily have to be in the particular order or sequential order shown to achieve the desirable results. In some implementations, multitasking and parallel processing may be advantageous.

Other embodiments of the present specification will readily come to mind to those skilled in the art upon consideration of the specification and practice of the invention applied for herein. The present specification is intended to cover any variations, uses, or adaptations of the present specification that follow the general principles of the present specification and include common knowledge or conventional technical means in the art not disclosed in the present specification. That is, this specification is not limited to the precise structure described above and illustrated in the drawings and is subject to various modifications and changes without departing from the scope thereof.

The foregoing are merely optional embodiments of this specification and are not intended to limit this specification. Any modifications, equivalent substitutions, improvements, etc., made within the spirit and principles of this specification shall be included within the scope of protection of this specification.

1. A method, comprising:
in response to an operation of generating a target page, acquiring a hierarchical relationship among widgets in the target page;
acquiring attribute information of the widgets based on the hierarchical relationship, wherein the attribute information comprises absolute position information of at least a first widget among the widgets as a root widget and relative position information of a second widget among the widgets as a leaf widget; and
generating a descriptive language file for the target page based on the attribute information.

2. The method according to claim 1, wherein acquiring the attribute information comprises:
generating one or more widget sets based on the hierarchical relationship, wherein each widget set of the one or more widget sets comprises a widget identifier of the first widget as a keyword, and stores a widget identifier of the second widget; and
acquiring, for any widget set of the one or more widget sets, the attribute information of the first widget corresponding to the widget set and the attribute information of the second widget in the widget set.

3. The method according to claim 2, wherein the attribute information is position information, and wherein acquiring the attribute information of the first widget comprises:
acquiring, for any widget set of the one or more widget sets, the absolute position information of the first widget corresponding to the widget set; and
in response to the widget set being not empty, acquiring the relative position information of at least one second widget in the widget set based on a type of the first widget and the absolute position information of the at least one second widget.

4. The method according to claim 3, wherein acquiring the relative position information comprises:
in response to the first widget being a container comprising only one second widget, determining position difference information of the second widget relative to the first widget as the relative position information of the second widget based on the absolute position information of the first widget and the absolute position information of the second widget;
in response to the first widget being a stack container comprising a plurality of second widgets, determining position difference information of each of the second widgets relative to the first widget as the relative position information of the each of the second widgets based on the absolute position information of the first widget and the absolute position information of the each of the second widgets; or
both.

5. The method according to claim 3, wherein acquiring the relative position information further comprises:
in response to the first widget being a row container comprising a plurality of second widgets, sorting the plurality of second widgets in an ascending order of horizontal coordinates of the plurality of second widgets, and determining the relative position information of the plurality of second widgets based on the result of sorting of the plurality of second widgets, the absolute position information of the plurality of second widgets, and the absolute position information of the first widget;
in response to the first widget being a column container comprising a plurality of second widgets, sorting the plurality of second widgets in an ascending order of vertical coordinates of the plurality of second widgets, and determining the relative position information of the plurality of second widgets based on the result of sorting of the plurality of second widgets, the absolute position information of the plurality of second widgets, and the absolute position information of the first widget; or
both.

6. The method according to claim 5, wherein determining the relative position information of the plurality of second widgets based on the result of sorting of the plurality of second widgets, the absolute position information of the plurality of second widgets, and the absolute position information of the first widget, comprises:
for the second widget with an order number of 1, determining the position difference information of the second widget with the order number of 1 relative to the first widget as the relative position information of the second widget with the order number of 1; and
for the second widget with the order number of N, determining the position difference information of the second widget with the order number of N relative to the second widget with the order number of N-1 as the relative position information of the second widget with the order number of N, wherein N is a positive integer not less than 2.

7. The method according to claim 1, wherein generating the descriptive language file comprises:
generating strings in a first preset format based on the attribute information of the widgets, wherein the strings describe the attribute information according to a format requirement of the first preset format; and
generating the descriptive language file based on the strings in the first preset format.

8. The method according to claim 1, wherein acquiring the hierarchical relationship among the widgets in the target page comprises:
in response to an operation of adding the widgets in a page development platform, displaying the target page based on the widgets added in the page development platform; and
acquiring the hierarchical relationship among the widgets in the target page, in response to the operation of generating the target page in the page development platform.

9. The method according to claim 8, wherein acquiring the hierarchical relationship comprises:
determining the hierarchical relationship based on a type and position information of each of the widgets in the target page.

10. The method according to claim 9, wherein determining the hierarchical relationship comprises:
traversing the widgets in the target page, and for each widget currently traversed, determining the hierarchical relationship among the each widget currently traversed and the other widgets in the target page based on the type of the each widget currently traversed and the position relationship among the each widget currently traversed and the other widgets.

11. The method according to claim 1, further comprising:
parsing and performing format conversion on the descriptive language file to convert the descriptive language file into a source code file.

12. The method according to claim 11, wherein parsing and performing format conversion on the descriptive language file comprises:
acquiring a directory list, wherein the directory list comprises a plurality of items, each of which comprises a subdirectory and/or the descriptive language file; and
for any one of the items in the directory list that comprises the descriptive language file, parsing and performing format conversion on the descriptive language file to convert the descriptive language file into the source code file, and for any one of the items in the directory list that comprises the subdirectory, acquiring the descriptive language file from the subdirectory, and parsing and performing format conversion on the descriptive language file to convert the descriptive language file into the source code file.

13. The method according to claim 12, wherein parsing and performing format conversion on the descriptive language file comprises:
for any first widget in the descriptive language file, performing format conversion on strings of the first widget and at least one second widget corresponding to the first widget in the descriptive language file based on a type of the first widget to obtain strings in a second preset format; and
generating the source code file based on the strings in the second preset format.

14. The method according to claim 1, further comprising:
acquiring a project identifier corresponding to the descriptive language file and a version of a device corresponding to an executable program file to be generated; and
generating the executable program file based on the project identifier and the version of the device.

15. (canceled)

16. A computing device, comprising a memory, a processor, and a computer program stored in the memory and executable on the processor, wherein the processor executes the computer program to implement the method according to claim 1.

17. A non-transitory computer-readable storage medium, in which a program is stored, wherein the program, when executed by a processor, implements the method according to claim 1.

18. The computing device according to claim 16, wherein acquiring the attribute information comprises:
generating one or more widget sets based on the hierarchical relationship, wherein each widget set of the one or more widget sets comprises a widget identifier of the first widget as a keyword, and stores a widget identifier of the second widget; and
acquiring, for any widget set of the one or more widget sets, the attribute information of the first widget corresponding to the widget set and the attribute information of the second widget in the widget set.

19. The computing device according to claim 16, wherein acquiring the hierarchical relationship among the widgets in the target page comprises:
in response to an operation of adding the widgets in a page development platform, displaying the target page based on the widgets added in the page development platform; and
acquiring the hierarchical relationship among the widgets in the target page, in response to the operation of generating the target page in the page development platform.

20. The non-transitory computer-readable storage medium according to claim 17, wherein acquiring the attribute information comprises:
generating one or more widget sets based on the hierarchical relationship, wherein each widget set of the one or more widget sets comprises a widget identifier of the first widget as a keyword, and stores a widget identifier of the second widget; and
acquiring, for any widget set of the one or more widget sets, the attribute information of the first widget corresponding to the widget set and the attribute information of the second widget in the widget set.

21. The non-transitory computer-readable storage medium according to claim 17, wherein acquiring the hierarchical relationship among the widgets in the target page comprises:
in response to an operation of adding the widgets in a page development platform, displaying the target page based on the widgets added in the page development platform; and
acquiring the hierarchical relationship among the widgets in the target page, in response to the operation of generating the target page in the page development platform.
